(19) United States
(12) Patent Application Publication
(10) Pub. No.: US 2013/0343686 A1
(43) Pub. Date: Dec. 26, 2013

(54) Low Resistance Wheel

(71) Applicant: Leroy Edwards, JR., Jurupa Valley, CA (US)

(72) Inventor: Leroy Edwards, JR., Jurupa Valley, CA (US)

(21) Appl. No.: 13/531,585

(22) Filed: Jun. 25, 2012

(51) Int. Cl. F16C 19/06

(52) U.S. Cl. CPC F16C 19/06
USPC 384/490

(57) ABSTRACT

This art is a part from, but more-so a means of enabling maneuverability. By the use of a large bearings to tumble over, and around it's circumfluence. The larger the circumfluence, the less drag would be imposed upon the maneuverability of the wheel chair.

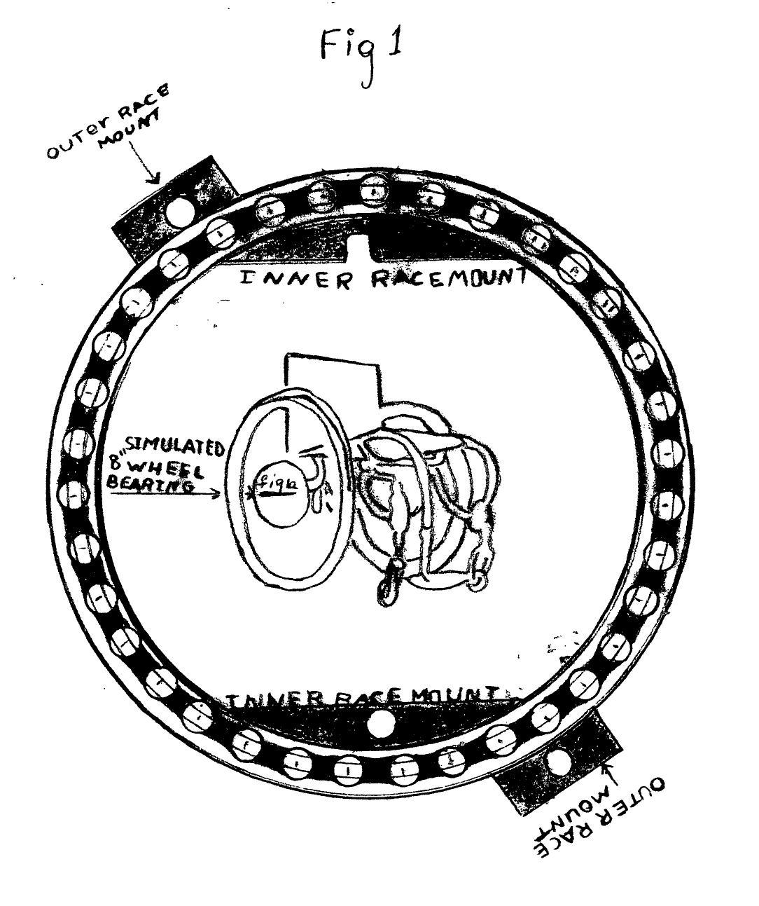

### CROSS-REFERENCE TO RELATED APPLICATIONS

None

### STATEMENT REGARDING FEDERALLY SPONSORED RESEARCH OR DEVELOPMENT

None

### THE NAMES OF THE PARTIES TO A JOINT RESEARCH AGREEMENT

None

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

None

### STATEMENT REGARDING PRIOR DISCLOSURES BY THE INVENTOR OR A JOINT INVENTOR OR A JOINT INVENTOR

None

### BACKGROUND OF THE INVENTION

None

(1) Field of Invention

(2) Description of Related Art Including Information Disclosed under 37 CFR 1/97 and 1.98.

### BRIEF SUMMARY OF THE INVENTION

Every effort should be made to assist people who have physical disabilities. By implementing this improvement (Low-Resistance-Wheel) on the standard wheel chair would greatly improve the rotability of the wheel chair.

### BRIEF DESCRIPTION OF THE SEVERAL VIEWS OF THE DRAWINGS(S)

None

### DETAILED DESCRIPTION OF THE INVENTION

By installing an eight inch diameter axis in place of a standard one half inch axis will eliminate drag the effect of “drag” will be over came by the effect of rolling, or tumbling in the description of force. The inclusion of an eight inch diameter axis into a twenty inch wheel will negotiate uneven surfaces more adequately.

1: By the implementation of a large bearing ring around the pivotal axis reduces drag of motion, enabling the wheel chair patient more control of movement over irregular surfaces.
